(19) United States
(12) Patent Application Publication
(10) Pub. No.: US 2017/0275735 A1
(43) Pub. Date: Sep. 28, 2017

(54) ECONOMICALLY ALLOYED TITANIUM ALLOY WITH PREDICTABLE PROPERTIES

(71) Applicant: PUBLIC STOCK COMPANY "VSMPO-AVISMA CORPORATION", Verkhnyaya Salda (RU)

(72) Inventors: Vladislav Valentinovich Tetyukhin, Moscow (RU); Natalia Yuryevna TARENKOVA, Verkhnyaya Salda (RU); Maria Anatolievna KORNILOVA, Verkhnyaya Salda (RU); Dmitriy Anatolievich RYMKEVICH, Berezniki (RU)

(21) Appl. No.: 15/509,173

(22) PCT Filed: Sep. 2, 2015
(86) PCT No.: PCT/RU2015/000555

§ 371 Date: Mar. 6, 2017

(30) Foreign Application Priority Data
Sep. 16, 2014 (RU) 2014137618

(51) Int. Cl. C22C 14/00; C22C 1/02; G12B 17/08; C22F 1/18

(52) U.S. Cl. CPC C22C 14/00; C22F 1/183; C22C 1/02; G12B 17/08

(57) ABSTRACT

The invention relates to the field of non-ferrous metallurgy, and more particularly to the creation of titanium alloys which, by virtue of their properties, are economical to use not only in traditional, particularly military, fields, but also in civilian fields of industry. The alloy contains 0.1-3.0 Al, 0.3-3.0 Fe, 0.1-1.0 Cr, 0.05-1.0 Ni, 0.02-0.3 Si, 0.02-0.2 N, 0.05-0.5 0, 0.02-0.1 C, and the remainder Ti. The technical result is the production of a commercially viable titanium alloy with guaranteed stable, predictable properties which is manufactured using, low-grade titanium sponge. This result is achieved in that the alloying elements used include impurity elements contained in the low-grade sponge, as well as alloying additives, separately added to the charge. The titanium-based alloy has a lower price compared to existing commercial alloys and, furthermore, the composition of the alloy is selected in accordance with a prescribed level of physical and mechanical properties and fabrication characteristics.

### FIELD OF THE INVENTION

This invention relates to non-ferrous metallurgy, namely to the development of titanium alloys, which, due to their advantageous properties, can be used not only for traditional applications, e.g. defense industry, but also for civil applications, such as automotive, chemical industry, machine building, power engineering, etc.

### BACKGROUND

It has been known, that spendings for expensive blend components amount to 75-85% of the total production costs in the cost of titanium ingots. The raw material for titanium alloys is titanium sponge produced via magnesium thermal process. There are six known grades of titanium sponge in Russia: TG-90, TG-100, TG-110, TG-120, TG-130, TG-150, TG-Tv, where TG in Russian stands for titanium sponge, Tv—for hard, and the numbers —for Brinell hardness. Their chemical compositions are given in Table 1.

TABLE 1

| | Chemical composition, % | | | | | | | | Hard- |
|---|---|---|---|---|---|---|---|---|---|
| | Ti, | Weight percentage of impurities, max. | | | | | | | ness, |
| Grade | min. | Fe | Si | Ni | C | Cr | N | O | HB |
| TG-90 | 99.74 | 0.05 | 0.01 | 0.04 | 0.02 | 0.08 | 0.02 | 0.04 | 90 |
| TG-100 | 99.72 | 0.06 | 0.01 | 0.04 | 0.03 | 0.08 | 0.02 | 0.04 | 100 |
| TG-110 | 99.67 | 0.09 | 0.02 | 0.04 | 0.03 | 0.08 | 0.02 | 0.05 | 110 |
| TG-120 | 99.64 | 0.11 | 0.02 | 0.04 | 0.03 | 0.08 | 0.02 | 0.06 | 120 |
| TG-130 | 99.56 | 0.13 | 0.03 | 0.04 | 0.03 | 0.10 | 0.03 | 0.08 | 130 |
| TG-150 | 99.45 | 0.20 | 0.03 | 0.04 | 0.03 | 0.12 | 0.03 | 0.10 | 150 |
| TG-Tv | 97.75 | 1.90 | 0.3 | 0.4 | 0.15 | 0.15 | 0.10 | 0.15 | >220 |

Use of titanium sponge TG-Tv for melting titanium alloys is limited because of the critical concentration of detrimental impurities, such as oxygen, nitrogen, carbon, iron, silicon, which react with titanium to form the alloys like interstitial solid solutions and intermetallic phases, which significantly deteriorate plasticity and processability of titanium,

These impurities have such a significant effect on the properties of alloys made of titanium, that it should be accounted for when making blend formula calculations to ensure the required level of mechanical properties.

Generation of low-grade sponge is explained by the specifics of hardware designed for magnesium thermal process which is used for sponge production. Sponge with the increased content of impurities is formed near the vessel walls and bottom. Usually this titanium sponge is segregated and limitedly used for titanium ingot melting or in ferrous metallurgy. The yield of such sponge ranges between 6 and 12%,

The prices of high-grade sponge are half as high (or even more) than the prices of low-grade sponge. Use of low-grade titanium sponge, TG-Tv grade in particular, is one of the most efficient solutions to cost reduction efforts implemented for titanium alloys.

There is a known titanium alloy consisting of, in weight percentages, 0.5 to 3,5 iron, 0.05 to 0.95 oxygen, 0 to 0,5 chromium, 0 to 3.5 aluminum, 0 to 3 vanadium, 0 to 0.3 carbon, 0 to 0.2 silicon, 0 to 0.1 manganese, 0 to 0.3 nickel, 0 to 0.2 nitrogen, balance titanium and unavoidable impurities (Patent JP 11036029, IPC C22C 14/00, publ. 02.09.1999).

Drawbacks of the prototype include low ductility and presence of expensive alloying elements—vanadium and manganese,

There is a known high strength, high ductility titanium alloy consisting of; in weight percentages 0.9 to 2.3 iron, up to and including 0.05 nitrogen and oxygen which concentration is controlled by the value of oxygen equivalent, Q, equal to 0.34-1.0 which is calculated per the following formula: Q=O+2.77N+0.1Fe, where O is oxygen concentration, wt. %, N is nitrogen concentration, wt. % and Fe is iron concentration, wt. %, here the tensile strength of titanium alloy is at least 700 MPa and percentage elongation is at least 15%. Fe may be partially replaced with Cr and Ni. These elements may be added to the alloy in the form of carbon or stainless steel, or they may be introduced with titanium sponge containing these elements (RF patent #2117065, IPC C22C14/00, publ. 10.08.1998) prototype.

A drawback of this alloy is its insufficient application flexibility due to low heat resistance, tight requirements for nitrogen concentration that limit the amount of low-grade sponge which can be introduced into the blend (e,g. concentration of nitrogen in titanium sponge TG-Tv is up to 0.1%).

### DETAILED DESCRIPTION

The object of this invention is development of titanium-base alloy with the cost lower than that of the existing marketable alloys and with the alloy composition selected based on the required level of physical, mechanical and processing properties.

A technical result of this invention is provision of competitive titanium alloy which:

1. has guaranteed stable and predictable properties.

2. is produced using low-grade titanium sponge,

This technical result is achieved with the help of sparingly alloyed titanium alloy with predictable properties consisting of iron, oxygen, nitrogen, chromium, nickel and additionally containing carbon, aluminum and silicon with the following ratio of the alloy components:

| | |
|---|---|
| Aluminum | 0.1-3.0 |
| Iron | 0.3-3.0 |
| Chromium | 0.1-1.0 |
| Nickel | 0.05-1.0 |
| Silicon | 0.02-0.3 |
| Nitrogen | 0.02-0.2 |
| Oxygen | 0.05-0.5 |
| Carbon | 0.02-0.1 |
| Titanium | balance, |

here the alloying elements include both impurities which are constituents of low-grade sponge and separately introduced alloying additions, weight percentages of alloying elements are interrelated and their composition is selected based on the predictable percentage elongation, δ, using reduced sum, Σ_{eq.}^{str.}, of strength equivalents: molybdenum [Mo]_{eq.}^{str.} and aluminum [Al]_{eq.}^{str.},

Σ_{eq.}^{str.}=27.63−δ

Σ_{eq.}^{str.}=1.11[Al]_{eq.}^{str.}+0.92[Mo]_{eq.}^{str.}

chemical elements vary within Σ_{eq.}^{str.} depending on chemical composition and available charge materials. Here molybdenum and aluminum strength equivalents are defined by the following ratios:

[Al]_{eq.}^{str.}=Al+20·O+33.N+12·C+3.3·Si, wt. %

[Mo]_{eq.}^{str.}=Cr/0.8+Fe/0.7+Ni, wt. %

The alloys have the following values of Σ_{eq.}^{str.}:
5 to 10—alloys that are mainly used for welded assemblies,
10 to 18—alloys that are mainly used for fiat rolled products,
18 to 22—alloys that are mainly used for structural applications,
   When formulating the blend, the tensile strength can be additionally predicted and adjusted per the following formula:

σ_{B}=235+60 [Al]_{eq.}^{str.}+50 [Mol]_{eq.}^{str.} (MPa)

The nature of the invention is effective use of low-grade sponge, the inherent impurities of which are used as efficient alloying elements.

The alloys will be of practical value only when they have stable target characteristics. Statistical observations demonstrate that low-grade sponge is characterized by great variations of the concentrations of chemical elements which automatically lead to great variations of structural and processing characteristics of the alloys melted using this sponge. In this case, in order to guarantee stable structural and processing characteristics of a marketable titanium alloy made of low-grade sponge, a widely used method of property control by chemical composition will be insufficient. There should be a more accurate method of formulating marketable product with predictable properties that would facilitate control of properties of these alloys.

As is known, oxygen, nitrogen, carbon act as alpha phase strengtheners and stabilizers in a way similar to aluminum. At the same time, the concentrations of these elements in the alloy shall be limited to certain values (0.5% of O, 0.1% of N, 0.1% of C), since higher concentrations lead to sharp deterioration of plastic properties because of the generation of ordered phases in the alloy, such as TiO phase. The latter drastically changes the mechanism of material deformation as a result of sharp reduction of the number of slip planes. These elements are interstitial impurities. Similar phenomena can be also detected in traditional titanium alloys containing more than 5 wt. % of Al, only in this case the alloy embrittlement is attributed to the generation of TiAl phase. Titanium sponge also contains substitutional impurities (Fe, Ni, Cr, Si). It should be noted that the effect of interstitial impurities on the properties is tenfold stronger than that of substitutional impurities. To increase the heat resistance, the alloy is additionally alloyed with aluminum.

A critical property of the claimed alloy is its plasticity which is sufficiently characterized by percentage elongation, δ. δ, in its turn, is directly related to the alloy chemical composition, which can be expressed in terms of the reduced sum Σ_{eq.}^{str.} of strength equivalents: molybdenum [Mo]_{eq.}^{str.} and aluminum [Al]_{eq.}^{str.},

Σ_{eq.}^{str.}=27.63−δ

The reduced sum of strength equivalents is expressed via the following relation:

Σ_{eq.}^{str.}=1.11[Al]_{eq.}^{str.}+0.92[Mo]_{eq.}^{str.}

Knowing specific chemical composition of titanium sponge, formulation of the predictable alloy can be easily accomplished by varying the ratio of chemical elements and values of molybdenum [Mo]_{eq.}^{str.} and aluminum [Al]_{eq.}^{str.} strength equivalents in compliance with the following relationships:

[Al]_{eq.}^{str.}=Al+20·O+33.N+12·C+3.3·Si, wt. %

[Mo]_{eq.}^{str.}=Cr/0.8+Fe/0.7+Ni, wt. %

In addition, strength properties of the claimed alloy may be predicted and controlled in compliance with the following relationship:

σ_{B}=235+60 [Al]_{eq.}^{str.}+50 [Mo]_{eq.}^{str.} (MPa)

Elements equivalent to aluminum strengthen titanium alloys mostly as a result of solution strengthening, and beta stabilizers—as a result of the increasing amount of stronger beta phase.

Alloys for welded assemblies have Σ_{eq.}^{str.} of 5 to 10 and are characterized by good weldablity. The increasing concentration of alloying elements will lead to excessive increase of hardness and decrease of deformation capability which may cause generation of cracks during welding. Mechanical properties: σ=580-750 MPa, elongation δ≧18%.

Alloys for flat rolled products have Σ_{eq.}^{str.} of 10 to 18. Mechanical properties: σ=800-4000 MPa, elongation δ≧10%.

Alloys for structural applications have Σ_{eq.}^{str.} of 18 to 22. Mechanical properties σ=1000-1300 MPa, elongation δ≧5%.

Oxygen increases strength and hardness of titanium. In the range of low concentrations (to 0.2%), every hundredth of a percent of oxygen increases the ultimate tensile strength by approximately 12.5 MPa. Oxygen reduces plastic properties of titanium in the range of low concentrations (to 0.2%) :from 40 down to 27%. In the range of 0.2-0.5% it has less impact on plastic properties (reduction is from 27 down to 17-20%), here plasticity still remains at acceptable levels. At higher oxygen concentrations (over 0.7 wt. %) titanium loses its plastic deformation capability. The optimal range of oxygen for alloying the proposed alloy is between 0.1 and 0.5%.

Nitrogen is better strengthener than oxygen. Every hundredth of a percent of nitrogen increases the ultimate tensile strength by almost 20 MPa. Nitrogen has also a stronger impact on plastic behavior, the alloys become brittle at nitrogen levels of 0.45 to 0.48%. When nitrogen concentration is 0.1%, the value of δ is within 20%.

Carbon in low concentrations (to 0.15%) acts similar to oxygen and nitrogen, although it is a less powerful strengthener: the alloy strength is increased by 5-6 MPa with carbon concentration increased by 0.01%.

When present in the alloy in concentrations exceeding 0.1%, carbon doesn't strengthen the metal much, however it deteriorates plasticity and toughness.

Aluminum, which is used almost in all commercial alloys, improves strength and heat resistance behavior of titanium. Every hundredth of a percent of aluminum increases the ultimate tensile strength by approximately 0,6 MPa. When aluminum concentration is up to 4%, the value of δ is within 15-20%.

Iron as alloying element in titanium is eutectoid beta stabilizer, which decreases the beta transus temperature; iron also strengthens titanium at ambient temperatures. Every hundredth of a percent of iron increases the ultimate tensile strength by approximately 0.75 MPa. Addition of iron to the alloy in concentrations between 0.3 and 3.0% increases the volume fraction of beta phase by reducing deformation resistance during hot working of the alloy, which helps to avoid generation of defects, such as cracks. When the iron concentration exceeds the upper limits, excessive segregation of solution might occur during ingot solidification, which will affect mechanical behavior. Fe in concentrations within 0.3-3.0% has no significant impact on plastic.

The claimed alloy contains small amounts of beta stabilizing elements: chromium, nickel and silicon, their amount in the alloy is defined by the concentrations in the low-grade titanium sponge. Every hundredth of a percent of chromium increases the ultimate tensile strength by approximately 0.65 MPa, of nickel—by 0,5 MPa, of silicon—by 2 MPa. The upper limit of Cr and Ni concentrations is 1%, of silicon—0.3%. Within these concentrations, their impact on percentage elongation is negligible. It should he noted, that presence of nickel in the alloy enhances corrosion resistance, while silicon enhances heat resistance. Iron, chromium, nickel and silicon are substitutional elements and increase the alloy strength. Their concentrations within the claimed ranges allow introduction of low-grade titanium sponge for blending while maintaining the claimed properties of the alloy.

### Experimental Section

Industrial applicability of the provided invention is proved by the following exemplary embodiments.

### EXAMPLE 1

Alloys that are mainly used for welded assemblies. Two ingots (weighing 23 kg each) of different chemical compositions were melted for experimental testing of properties of the claimed alloy. The ingots were produced by double inciting using the available titanium sponge of TG-Tv grade which amounted to 98%. The melted ingots were forged and rolled to produce 30-32 mm diameter bars. Mechanical tests were performed after annealing (730° C., soaking for 1 hour, air cooling).

The required values of percentage elongation, 6, were 18 and 22% correspondingly.

The blend was formulated in compliance with the above calculations, the results of which are given in Table 2.

TABLE 2

| | Required | | Selected | Composition of charge materials |
|---|---|---|---|---|
| Composition | δ% | Σ_{eq.}^{str.} | equivalents | ensuring the required ratio of equivalents |
| 1 | 18 | 9.6 | [Al]_{eq.}^{str.} = 5.6 | Titanium sponge TG-Tv - 97.6%; |
| | | | [Mo]_{eq.}^{str.} = 1.06 | Pure Al - 2.3%; |
| | | | | Rutile - 0.1%. |
| 2 | 22 | 5.6 | [Al]_{eq.}^{str.} = 4.2 | Titanium sponge TG-Tv - 50%; |
| | | | [Mo]_{eq.}^{str.} = 0.53 | Titanium sponge TG 90 - 48.82%; |
| | | | | Pure Al - 1.1% |
| | | | | Rutile - 0.08%. |

Chemical composition of the alloys is given in Table 3.

TABLE 3

| Composition | O | N | C | Al | Fe | Cr | Si | Ni |
|---|---|---|---|---|---|---|---|---|
| 1 | 0.21 | 0.03 | 0.02 | 2.32 | 0.65 | 0.1 | 0.015 | 0.08 |
| 2 | 0.12 | 0.02 | 0.015 | 1.08 | 0.31 | 0.54 | 0.02 | 0.11 |

The reduced sum Σ_{eq.}^{str.} of strength equivalents, the actual and calculated percentage elongation, the actual and calculated tensile strength are given in Table 4.

TABLE 4

| | | Percentage elongation | | Tensile strength | |
|---|---|---|---|---|---|
| | | δ, % | | σ_{B} [MPa] | |
| Composition | Σ_{eq.}^{str.} | actual | calculated | actual | calculated |
| 1 | 9.23 | 18.4 | 18 | 720 | 756 |
| 2 | 5.49 | 22.14 | 22 | 563 | 580 |

### EXAMPLE 2

### Alloys that are Mainly Used for Flat Rolled Products

Chemical compositions were formulated using the available titanium sponge of TG-Tv grade, aluminum, Steel St3 and rutile based on the required percentage elongation. The ingots were produced by double melting and converted to rolling stock to produce thin rolled sheet (gauge 2 mm) with subsequent annealing.

The required percentage elongations, δ, for two different applications, were 10 and 17% correspondingly.

The blend was formulated in compliance with the above calculations, the results of which are given in Table 5.

TABLE 5

| | | | | Composition of |
|---|---|---|---|---|
| | | | | charge materials |
| | | | | ensuring |
| | Required | | Selected | the required |
| Composition | δ% | Σ_{eq.}^{str.} | equivalents | ratio of equivalents |
| 3 | 10 | 17.6 | [Al]_{eq.}^{str.} = 9.2 | Titanium sponge |
| | | | [Mo]_{eq.}^{str.} = 6.1 | TG-Tv - 94.9%; |
| | | | | St3 - 2%; |
| | | | | Pure Al - 3%; |
| | | | | Rutile - 0.1%. |
| 4 | 17 | 10.6 | [Al]_{eq.}^{str.} = 6.3 | Titanium sponge |
| | | | [Mo]_{eq.}^{str.} = 3.78 | TG-Tv - 95.82%; |
| | | | | St3 - 2.1%; |
| | | | | Pure Al - 2%; |
| | | | | Rutile - 0.08%. |

Chemical composition of the ingots is given in Table 6

TABLE 6

| Composition | O | N | C | Al | Fe | Cr | Si | Ni |
|---|---|---|---|---|---|---|---|---|
| 3 | 0.2 | 0.03 | 0.02 | 2.97 | 2.9 | 1.08 | 0.01 | 0.5 |
| 4 | 0.1 | 0.02 | 0.015 | 2.04 | 2.0 | 0.57 | 0.02 | 0.3 |

The reduced sum Σ_{eq.}^{str.} of strength equivalents, the actual and calculated percentage elongation, the actual and calculated tensile strength are given in Table 7.

TABLE 7

| | | Percentage elongation | | Tensile strength | |
|---|---|---|---|---|---|
| | | δ, % | | σ_{B} [MPa] | |
| Composition | Σ_{eq.}^{str.} | actual | calculated | actual | calculated |
| 3 | 17.3 | 10.31 | 10 | 985 | 1100 |
| 4 | 11.7 | 15.89 | 17 | 834 | 810 |

One sheet was taken for periodic testing (in compliance with the requirements of AMS4911) to determine a bend angle. The test results are given in Table 8.

TABLE 8

| Specimen | Sampling | | Bend angle, mandrel |
|---|---|---|---|
| No. | direction | Bend angle, mandrel 10t | 9t |
| 3 | L | 117/180 | 117/180 |
| 4 | L | 111/180 | 111/180 |
| 3 | LT | 117/180 | 117/180 |
| 4 | LT | 111/180 | 111/180 |

### EXAMPLE 3

### Alloys that are Mostly Used for Structural Applications

The test specimens were fabricated similar to the specimens in example 1.

The required values of percentage elongation, δ, were 5 and 7% correspondingly.

The blend was formulated in compliance with the above calculations, the results of which are given in Table 9.

TABLE 9

| | | | | Composition of |
|---|---|---|---|---|
| | | | | charge materials |
| | | | | ensuring the |
| | Required | | Selected | required ratio of |
| Composition | δ% | Σ_{eq.}^{str.} | equivalents | equivalents |
| 5 | 5 | 22.6 | [Al]_{eq.}^{str.} = 13.4 | Titanium sponge |
| | | | [Mo]_{eq.}^{str.} = 6.0 | TG-Tv - 93.6%; |
| | | | | St3 - 2%; |
| | | | | Pure Al - 3%; |
| | | | | Pure |
| | | | | chromium - 0.7%; |
| | | | | Pure nickel - 0.5%; |
| | | | | Rutile - 0.2%. |
| 6 | 7 | 18.6 | [Al]_{eq.}^{str.} = 10.6 | Titanium sponge |
| | | | [Mo]_{eq.}^{str.} = 3.0 | TG-Tv - 95.65%; |
| | | | | St3 - 0.7%; |
| | | | | Pure Al - 3%; |
| | | | | Pure |
| | | | | chromium - 0.3%; |
| | | | | Pure nickel - 0.2%; |
| | | | | Rutile - 0.2%. |

Chemical composition of the alloys is given in Table 10.

TABLE 10

| Composition | O | N | C | Al | Fe | Cr | Si | Ni |
|---|---|---|---|---|---|---|---|---|
| 5 | 0.4 | 0.06 | 0.03 | 2.98 | 2.85 | 0.88 | 0.02 | 0.51 |
| 6 | 0.3 | 0.04 | 0.02 | 2.96 | 1.53 | 0.56 | 0.03 | 0.31 |

The reduced sums Σ_{eq.}^{str.} of strength equivalents, the actual and calculated percentage elongation, the actual and calculated tensile strength are given in Table 11.

TABLE 11

| | | Percentage elongation | | Tensile strength | |
|---|---|---|---|---|---|
| | | δ, % | | σ_{B} [MPa] | |
| Composition | Σ_{eq.}^{str.} | actual | calculated | actual | calculated |
| 5 | 22.5 | 5.18 | 5 | 1258 | 1340 |
| 6 | 18.7 | 8.91 | 9 | 1115 | 1020 |

As seen from the above examples, production of low cost titanium alloys according to this invention, solves the problem of introduction of low-grade sponge to produce a final product with the required processing and structural properties. Therefore, this invention ensures high efficiency of industrial application.

It should be understood, that this specification discloses those aspects of the invention that are required for its clear understanding. Some aspects of the invention that will be obvious to a person with ordinary skills in the art and therefore won't facilitate understanding of this invention, were not disclosed in order to simplify the description of this invention. Although the exemplary embodiments of this invention were presented, a person with ordinary skills in the art having reviewed the provided description, will clearly understand that there may be many modifications and changes made to the invention. All such changes and modifications of this invention shall be considered to fall within the scope of the above description and the attached claim.

1. A sparingly alloyed titanium alloy comprising alloying elements in a ratio, the ratio of the alloying elements is:

| | |
|---|---|
| Aluminum | 0.1-3.0, |
| Iron | 0.3-3.0, |
| Chromium | 0.1-1.0, |
| Nickel | 0.05-1.0, |
| Silicon | 0.02-0.3, |
| Nitrogen | 0.02-0.2, |
| Oxygen | 0.05-0.5, |
| Carbon | 0.02-0.1, and |
| Titanium | balance[[,]]; |

wherein at least one of the alloying elements is an impurity that is a constituent of a of low-grade titanium sponge, and at least one of the alloying elements is a separately introduced alloying addition;
wherein weight percentages of the alloying elements in the sparingly alloyed titanium alloy are selected based on the predictable percentage elongation, δ, using reduced sum, Σ_{eq.}^{str.}, of strength equivalents, molybdenum [Mo] and aluminum [Al]_{eq.}^{str.},
Σ_{eq.}^{str.}=27.63−δ
Σ_{eq.}^{str.}=1.11[Al]_{eq.}^{str}+0.92[Mo]_{eq.}^{str.};
wherein molybdenum and aluminum strength equivalents are defined by the following ratios:
[Al]_{eq.}^{str.}=Al+20·O+33·N+12·C+3.3·Si, wt. %
[Mo]_{eq.}^{str.}=Cr/0.8+Fe/0.7+Ni, wt. %.

2. The alloy of claim 1, wherein the sparingly alloyed titanium alloy has a tensile strength that is predicted per the following formula:
σ_{B}=235+60 [Al]_{eq.}^{str.}+50 [Mol]_{eq.}^{str.} (MPa).

3. The alloy of claim 1, wherein the sparingly alloyed titanium alloy has a Σ_{eq.}^{str.}: value of −5 to 10.

4. The alloy of claim 1, wherein the sparingly alloyed titanium alloy has a Σ_{eq.}^{str.}: value of −10 to 18.

5. The alloy of claim 1, wherein the sparingly alloyed titanium alloy has a Σ_{eq.}^{str.}: value of −18 to 22.
